(19) United States
(12) Patent Application Publication
(10) Pub. No.: US 2012/0248234 A1
(43) Pub. Date: Oct. 4, 2012

(54) RECORDING TAPE CARTRIDGE

(75) Inventor: Kazuo HIRAGUCHI, Kanagawa (JP)

(73) Assignee: FUJIFILM CORPORATION, Tokyo (JP)

(21) Appl. No.: 13/427,927

(22) Filed: Mar. 23, 2012

(30) Foreign Application Priority Data
Mar. 31, 2011 (JP) 2011-079243

(51) Int. Cl. G11B 23/107

(52) U.S. Cl. 242/348.2

(57) ABSTRACT

A leader pin is fabricated by die-casting, is attached to a free-end portion of a recording tape, and is drawn out through an opening formed in a case. A plate spring retains axial direction both end portions of the leader pin such that the leader pin does not fall from inside the case. When the leader pin is being mounted at or removed from the case, the plate spring is pushed by the end portions and resiliently deforms, and allows the mounting or removal operation of the leader pin. A flat surface portion is formed at the leader pin so as to remove parting line portion of the leader pin. The leader pin is attached to the free-end portion at an angle relative to a tension direction of the free-end portion, such that the flat surface portions formed at the end portions do not contact with the plate spring.

### CROSS-REFERENCE TO RELATED APPLICATION

This application claims priority under 35 USC 119 from Japanese Patent Application No. 2011-079243 filed Mar. 31, 2011, the disclosure of which is incorporated by reference herein.

### BACKGROUND OF THE INVENTION

1. Field of the Invention

The present invention relates to a recording tape cartridge that accommodates a single reel onto which a recording tape such as a magnetic tape or the like is wound, principally for use as a recording/replaying medium for computers and the like.

2. Related Art

Heretofore, a recording tape cartridge has been known in which a recording tape such as a magnetic tape or the like, which is used as a data recording/replaying medium (data backup) for computers and the like, is wound on a reel and this reel is singly accommodated in a case. A leader pin, for a drawing member of a drive device to engage with and draw out, is attached to a free end portion of the recording tape or of a leader tape connected to the recording tape. Fabricating this leader pin by die-casting a metal alloy is known (for example, see Japanese Patent Application Laid-Open (JP-A) No. 2010-250873).

At a leader pin that is fabricated by die-casting of a metal alloy, a flashing (burr), a stepped edge or the like is formed at a parting line portion along the axial direction. When such flashing or stepped edge is formed in the axial direction, there is a risk of the free end portion of the recording tape or leader tape connected to the recording tape being damaged by the flashing or stepped edge. Therefore, in order to prevent this damage, a flat portion (what is known as a D-cut) is formed in the axial direction in the parting line portion in the leader pin.

However, if the leader pin is attached to the free end of the recording tape or the leader tape connected to the recording tape in such a way that distal end portions of a plate spring, which retain the both end portions of the leader pin when the leader pin is accommodated in the case, are in contact with a flat surface portion formed at a parting line portion at the both end portions, spring force of the distal end portions of the plate spring on the both end portions of the leader pin accommodated in the case may be inconsistent.

### SUMMARY OF THE INVENTION

Accordingly, in consideration of the above circumstances, an object of the present invention is to provide a recording tape cartridge in which, when a leader pin that is fabricated by die-casting and at which a flat surface portion is formed at a parting line portion is accommodated in a case, the leader pin is properly retained by a plate spring.

In order to achieve the object described above, a recording tape cartridge according to a first aspect of the present invention includes: a reel around which a recording tape is wound; a case that singly accommodates the reel in a rotatable manner; a leader pin that is manufactured by die-casting of one of a zinc alloy, an aluminium alloy, a magnesium alloy or a copper alloy, and that is attached to a free end portion of one of the recording tape or of a sheet-form member connected to the recording tape, the leader pin being drawn out through an opening formed in the case by a drawing member of a drive device; a plate spring that retains both end portions of the leader pin in an axial direction thereof such that the leader pin does not fall from inside the case and that, when the leader pin is being mounted at or removed from the case, resiliently deforms due to being pushed by the both end portions to allow mounting and removal operations of the leader pin; and flat surface portions formed at the leader pin such that parting line portions of the leader pin are removed, wherein the leader pin is attached to the free end portion such that an angle of the leader pin with respect to a tension direction of the free end portion is an angle such that the flat surface portions formed at the both end portions do not come into contact with the plate spring.

According to the first aspect of the invention, the leader pin that is fabricated by die-casting and at which the flat surface portions are formed at parting line portions is attached to the free end portion of the recording tape or the sheet-form member connected to the recording tape such that the angle of the leader pin with respect to the tension direction of the free end portion is the angle such that the flat surface portions formed at the both end portions do not come into contact with the plate spring. Therefore, the leader pin may be properly retained by the plate spring.

A recording tape cartridge according to a second aspect of the present invention includes: a reel around which a recording tape is wound; a case that singly accommodates the reel in a rotatable manner; a leader pin that is manufactured by die-casting of one of a zinc alloy, an aluminium alloy, a magnesium alloy or a copper alloy, and that is attached to a free end portion of one of the recording tape or of a sheet-form member connected to the recording tape, the leader pin being drawn out through an opening formed in the case by a drawing member of a drive device; a plate spring that retains both end portions of the leader pin in an axial direction thereof such that the leader pin does not fall from inside the case and that, when the leader pin is being mounted at or removed from the case, resiliently deforms due to being pushed by the both end portions to allow mounting and removal operations of the leader pin; and flat surface portions formed at at least the both end portions of the leader pin corresponding to parting line portions of the leader pin, wherein the leader pin is attached to the free end portion such that an angle of the leader pin with respect to a tension direction of the free end portion is an angle such that the flat surface portions formed at the both end portions do not come into contact with the plate spring.

According to the second aspect of the invention, the leader pin that is fabricated by die-casting and at which flat surface portions are formed at at least the both end portions of the leader pin corresponding to parting line portions of the leader pin is attached to the free end portion of the recording tape or the sheet-form member connected to the recording tape such that the angle of the leader pin with respect to the tension direction of the free end portion is the angle such that the flat surface portions formed at the both end portions do not come into contact with the plate spring.

A recording tape cartridge according to a third aspect of the present invention is the recording tape cartridge according to the first aspect or the second aspect in which the leader pin includes: head portions that are formed at the both end portions of the leader pin and have a thick plate shape, the head portions being retained by the plate spring; flange portions that are formed at the axial direction inner sides relative to the head portions and have a thin plate shape; and a main body portion that is between the flange portions and to which the free end portion is attached, and wherein a width of the flat surface portion formed at the head portion is larger than a width of the flat surface portion formed at the main body portion.

According to the third aspect of the invention, because the width of the flat surface portion formed at the head portion is greater than the width of the flat surface portion formed at the main body portion, when the free end portion of the recording tape or the sheet-form member connected to the recording tape is being attached to the leader pin, the leader pin can be positioned in the circumferential direction thereof by the flat surface portions at the head portions being placed face down on a flat face (for example, of a support pedestal). Therefore, an operation of attaching the free end portion to the leader pin is easier.

A recording tape cartridge according to a fourth aspect of the present invention is the recording tape cartridge according to any one of the first to third aspects in which the leader pin is subjected to surface processing including polytetrafluoroethylene processing.

According to the fourth aspect of the invention, a leader pin with an excellent low-friction characteristic is provided.

A recording tape cartridge according to a fifth aspect of the present invention is the recording tape cartridge according to any one of the first to fourth aspects in which the plate spring is subjected to surface processing including polytetrafluoroethylene processing.

According to the fifth aspect of the invention, a plate spring with an excellent low-friction characteristic is provided.

A recording tape cartridge according to a sixth aspect of the present invention is the recording tape cartridge according to any one of the first to third aspects in which the leader pin is resin-coated only at the both end portions that are retained by the plate spring.

According to the sixth aspect of the invention, a leader pin with an improved low-friction characteristic at least at the both end portions (the head portions) that touch against the plate spring is provided.

Further, it is possible in any one of the first to sixth aspects of the invention in which the recording tape cartridge further includes a retention portion that retains the leader pin inside the case, wherein the leader pin is attached to the free end portion such that the flat surface portions formed at the both end portions do not come into contact with the plate spring in a state in which the leader pin is retained at the retention portion.

Further, it is possible in any one of the first to sixth aspects of the invention in which the recording tape cartridge further includes a retention portion that retains the leader pin inside the case, wherein the leader pin is attached to the free end portion such that the flat surface portions formed at the both end portions do not come into contact with the plate spring at time of mounting to and removal from the retention portion of the leader pin.

As described above, according to the present invention, a recording tape cartridge can be provided in which, when a leader pin that is fabricated by die-casting and at which flat surface portions are formed at parting line portions is accommodated in a case, the leader pin is properly retained by a plate spring.

### BRIEF DESCRIPTION OF THE DRAWINGS

Embodiments of the invention will be described in detail with reference to the following figures, wherein:

FIG. 1 is a schematic perspective diagram of a recording tape cartridge provided with a leader pin.

FIG. 2 is a perspective diagram of the leader pin.

FIG. 3 is a perspective diagram illustrating the fixed side of a mold for fabricating the leader pin.

FIG. 4 is a perspective diagram illustrating the movable side of the mold for fabricating the leader pin.

FIG. 5 is a perspective diagram illustrating the leader pin just after being ejected from the movable side of the mold.

FIG. 6 is a magnified perspective diagram illustrating a head portion of the leader pin ejected from the mold.

FIG. 7A is a sectional diagram illustrating the sizes of flat surface portions formed at parting line portions at the head portion of the leader pin.

FIG. 7B is a sectional diagram illustrating the sizes of flat surface portions formed at parting line portions at an engagement portion of the leader pin.

FIG. 7C is a sectional diagram illustrating the sizes of flat surface portions formed at parting line portions at an attachment portion of the leader pin.

FIG. 8 is an exploded perspective diagram showing the leader pin before a free end portion of a recording tape or leader tape is attached by a clip.

FIG. 9A is a sectional diagram illustrating the leader pin relating to a present exemplary embodiment after the free end portion of the recording tape or leader tape is attached by the clip.

FIG. 9B is a sectional diagram illustrating a leader pin relating to a comparative example after a free end portion of a recording tape or leader tape is attached by a clip.

FIG. 10A is a plan diagram illustrating a state in which the leader pin relating to the present exemplary embodiment is accommodated in a case.

FIG. 10B is a plan diagram illustrating a state when the leader pin relating to the present exemplary embodiment is returned to the case.

FIG. 11A is a plan diagram illustrating a state in which a leader pin relating to a comparative example is accommodated in a case.

FIG. 11B is a plan diagram illustrating a state when the leader pin relating to the comparative example is returned to the case.

FIG. 12A is a plan diagram illustrating a state in which a leader pin relating to a comparative example is accommodated in a case.

FIG. 12B is a plan diagram illustrating a state when the leader pin relating to the comparative example is returned to the case.

### DETAILED DESCRIPTION OF THE INVENTION

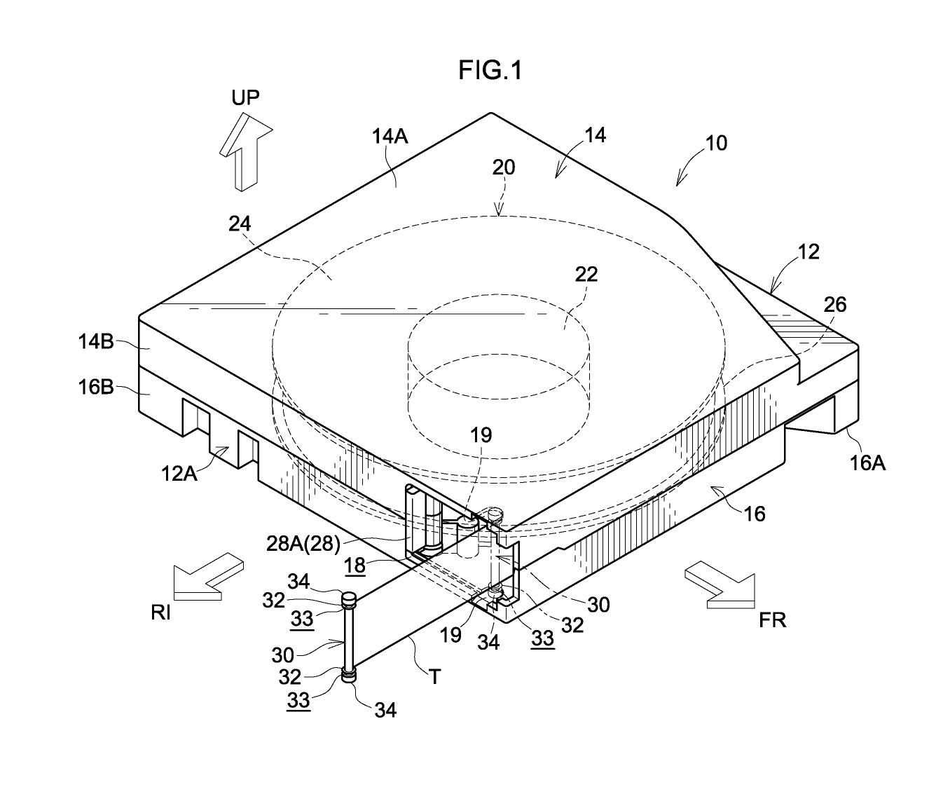

Herebelow, an exemplary embodiment relating to the present invention is described in detail in accordance with the attached drawings. For convenience of description, in FIG. 1, a direction of loading of a recording tape cartridge 10 into a drive device is indicated by the arrow FR and is referred to as a forward direction (front side) of the recording tape cartridge 10. The direction of an arrow RI that is orthogonal to the arrow FR is referred to as a rightward direction (right side). A direction orthogonal to the arrow FR and the arrow RI is indicated by the arrow UP and is referred to as an upward direction (upper side) of the recording tape cartridge 10. First, overall structure of the recording tape cartridge 10 is described.

As illustrated in FIG. 1, the recording tape cartridge 10 includes a substantially rectangular box-shaped case 12. A peripheral wall 14B is provided standing from a peripheral edge of a ceiling plate 14A of an upper case 14 that is fabricated of resin. A peripheral wall 16B is provided standing from a peripheral edge of a floor plate 16A of a lower case 16 that is fabricated of resin. The case 12 is constituted by the peripheral wall 14B and the peripheral wall 16B being abutted together and joined in this state by screw-fixing or the like. A single reel 20 that is fabricated of resin is rotatably accommodated inside this case 12.

The reel 20 is constituted by a reel hub 22, a lower flange 26 and an upper flange 24. The reel hub 22 has the form of a circular tube with a bottom, which structures an axial portion. The lower flange 26 is provided at a lower end portion of the reel hub 22, and the upper flange 24 is provided at an upper end portion of the reel hub 22. A recording tape T such as a magnetic tape or the like that serves as an information recording and replaying medium is wound onto an outer periphery face of the reel hub 22. Width direction end portions of the wound recording tape T are retained by the upper flange 24 and the lower flange 26.

A reel gear (not illustrated in the drawings in the drawings) is formed in an annular shape at a lower face of the bottom wall of the reel hub 22. A gear opening (not illustrated in the drawings) for exposing the reel gear to the outside is formed in a substantially central portion of the lower case 16. The reel gear exposed through the gear opening meshes with a driving gear (not illustrated in the drawings) that is formed at a rotary shaft (not illustrated in the drawings) of a drive device, and is driven to rotate. Thus, the reel 20 is relatively rotatable inside the case 12 with respect to the case 12.

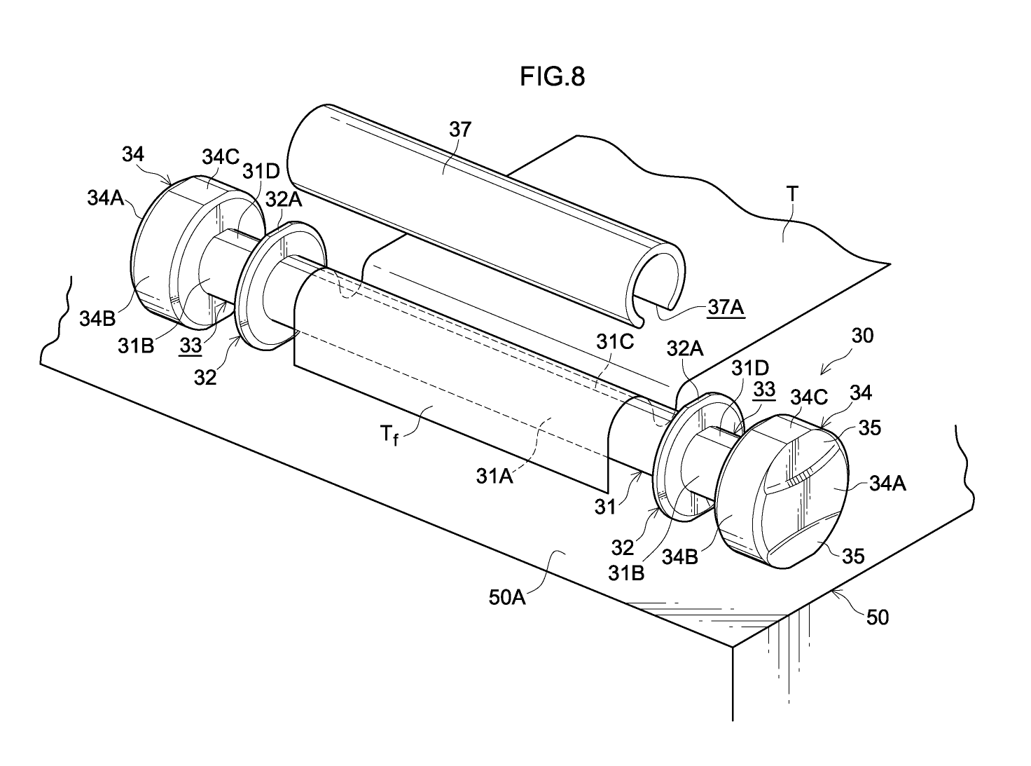

An opening 18 for drawing out of the recording tape T wound onto the reel 20 is formed in a right wall 12A of the case 12. A leader pin 30 is fixed to a free end portion Tf (see FIG. 8) of the recording tape T or of a leader tape (not illustrated in the drawings) that serves as an example of a sheet-form member connected to the recording tape T, that is drawn out (pulled out) through the opening 18. The leader pin 30 is caught up (engaged) by a drawing (pulling out) member (not illustrated in the drawings) of the drive device and operated to be drawn out.

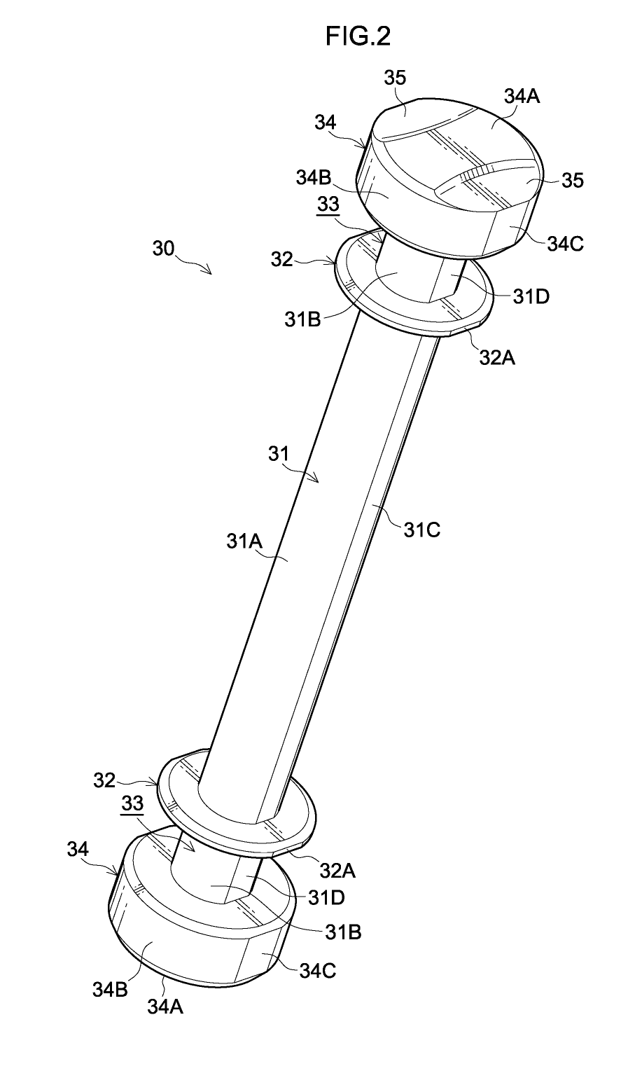

As is illustrated in detail in FIG. 2, at the leader pin 30, a head portion 34 with a thick plate shape is integrally formed at each of two (both) axial direction end portions of a circular rod-form main body portion 31. At predetermined positions of the main body portion 31 at the axial direction inner sides of the head portions 34, flange portions 32 with a thin plate shape are integrally formed with a predetermined spacing.

In this structure, the free end portion Tf of the recording tape T or the leader tape connected to the recording tape T is attached (fixed) to the main body portion 31 (hereinafter, this is referred to as an attachment portion 31A) between the flange portions 32. Each part of the main body portion 31, which is between the flange portion 32 and the head portion 34 (hereinafter referred to as an engaging portion 31B) serves as an annular slot (groove) portion on which a hook or the like of the drawing member of the drive device catches.

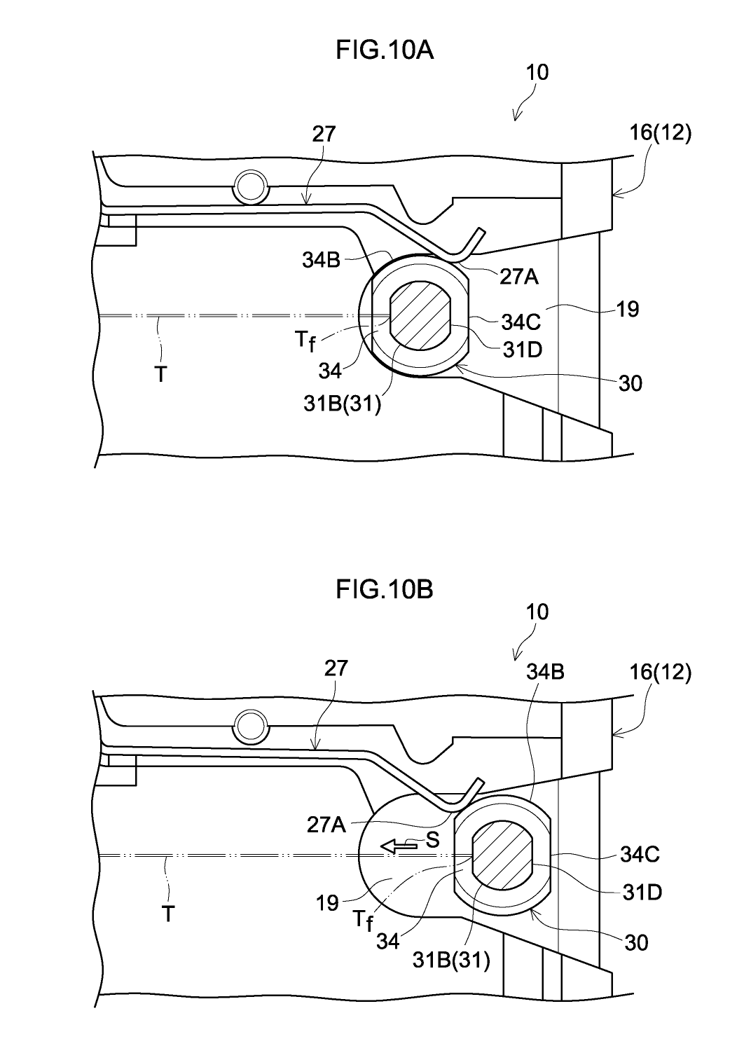

As illustrated in FIG. 1, a pair of upper and lower pin retention portions 19 are formed at the inner side of the opening 18 of the case 12 (see also FIGS. 10A and 10B to FIGS. 12A and 12B). The pin retention portions 19 are provided at the inner face of the ceiling plate 14A of the upper case 14 and the inner face of the floor plate 16A of the lower case 16. The pin retention portions 19 position and retain the head portions 34 of the leader pin 30 within the case 12.

Each pin retention portion 19 is formed in a substantially semi-circular shape that is open to the recording tape T drawing-out side, and is formed such that the head portion 34 of the leader pin 30 in an upright state can be put into and taken out from inside the pin retention portion 19 through the open side. An outer face 34A (see FIG. 2) in the axial direction of the head portion 34 that comes into contact with the pin retention portion 19 is formed substantially as a spherically curved surface.

A plate spring 27 (see FIGS. 10A and 10B to FIGS. 12A and 12B) is disposed in a vicinity of the pin retention portions 19. Distal end portions 27A of the plate spring 27 are in a fork form and are bent in substantially circular arc shapes in plan view. The portion of the distal end portion 27A that is bent in the substantially circular arc shape in plan view engages with (presses against) each peripheral face portion 34B (see FIG. 2) of the head portion 34 so retaining (holding) the leader pin 30 in the pin retention portions 19. Each peripheral face portion 34B is a curved surface with a circular arc shape.

When the leader pin 30 (the head portions 34) is being put into or taken out from the pin retention portions 19 (attached or removed), each distal end portion 27A of the plate spring 27 is pushed (pressed) in a direction orthogonal to a direction of movement of the leader pin 30 (a mounting/removal direction) in plan view and resiliently deforms, thus allowing movement (a mounting/removal operation) of the leader pin 30.

When the leader pin 30 (the head portions 34) is accommodated at the pin retention portions 19 (when the recording tape cartridge 10 is not in use), the leader pin 30 (the head portions 34) may be constantly urged by the plate spring 27, or may be not urged (a state in which there is “play”).

The opening 18 is opened and closed by a door 28. The door 28 is formed in a size, having substantially rectangular plate shape, that is capable of closing off the opening 18. The door 28 is urged in a direction of closing the opening 18 by an unillustrated urging member. At a front end portion of the door 28, a protrusion portion 28A for opening and closing operations is provided protruding outward. The protrusion portion 28A is engaged with an opening and closing member (not illustrated in the drawings) of the drive device in accordance with loading of the recording tape cartridge 10 into the drive device. Accordingly, the door 28 is opened in opposition to the urging force of the urging member.

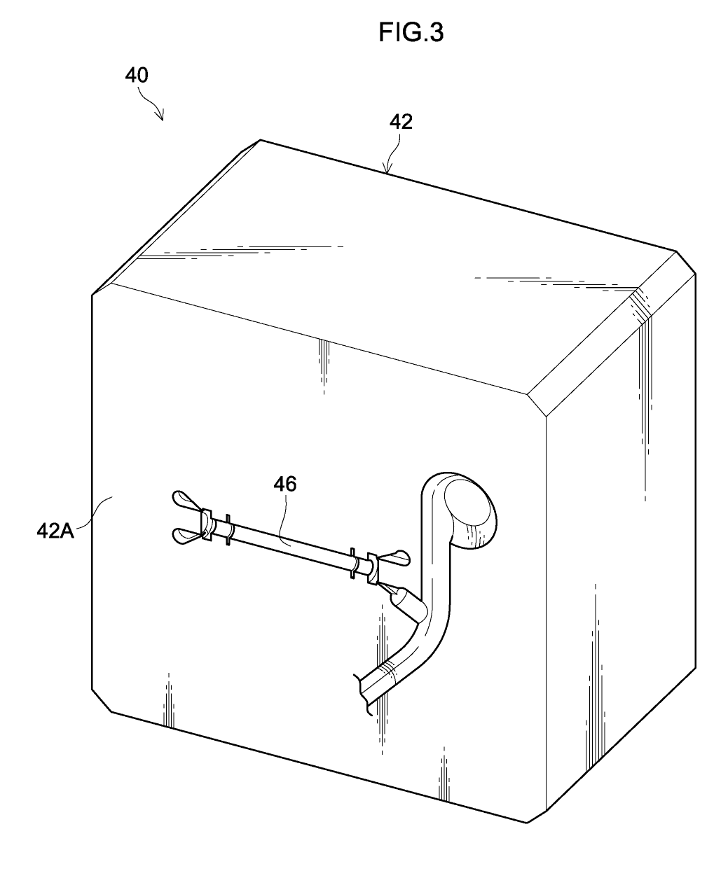

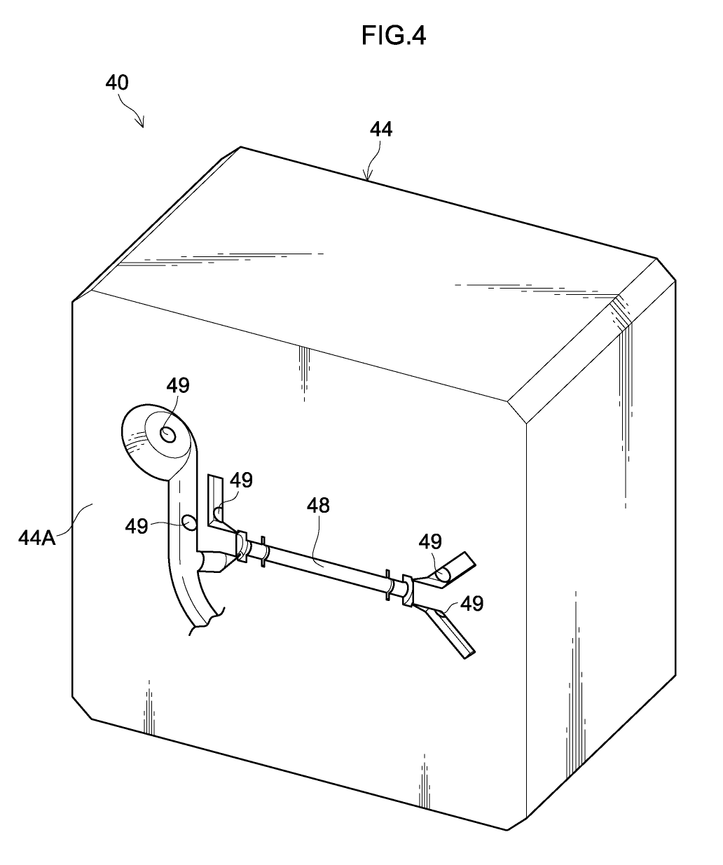

Next, the leader pin 30 of the recording tape cartridge 10 with the structure described above is described in detail. As illustrated in FIG. 3 to FIG. 5, the leader pin 30 is fabricated by die-casting of a metal alloy. That is, a material of the leader pin 30 is one of metal alloy from among zinc alloys, aluminium alloys, magnesium alloys and copper alloys. The leader pin 30 is fabricated (manufactured) by a die (mold) 40, which is illustrated in FIG. 3 and FIG. 4.

The die 40 is a metallic mold, and is constituted by a core 42 illustrated in FIG. 3, which is the fixed side, and a cavity 44 illustrated in FIG. 4, which is the movable side. The cavity 44 is moved toward and moved away from the core 42 by an unillustrated moving mechanism. Recess portions 46 and 48 for forming the leader pin 30 are formed in mating faces 42A and 44A of the core 42 and the cavity 44, respectively.

Thus, if, for example, the leader pin 30 is to be fabricated of a zinc alloy, the mating face 44A of the cavity 44 is mated with the mating face 42A of the core 42 and clamped, and molten zinc alloy is injected into the recess portions 46 and 48. After the shape of the leader pin 30 has been formed, the cavity 44 is moved away from the core 42.

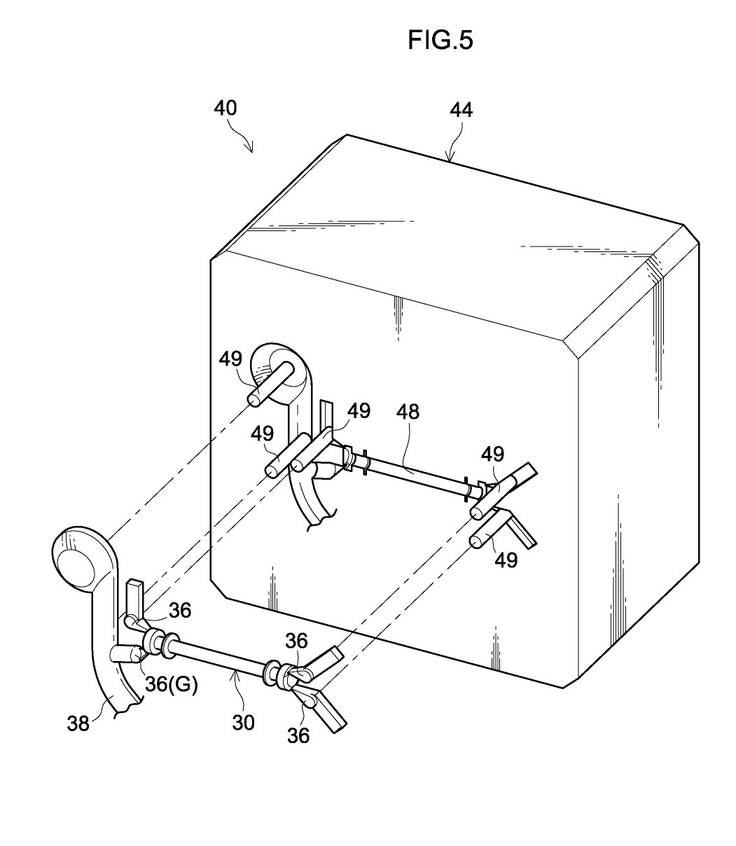

Accordingly, the leader pin 30 (including overflow portions 36 and a runner 38, which are described below, or the like) is extracted from the core 42 in a state of being fixed at the cavity 44 side. Thereafter, as illustrated in FIG. 5, the leader pin 30 is ejected (pushed out) by plural ejector pins 49 provided at the cavity 44, and is extracted from the cavity 44. Then, the below-described overflow portions 36 and runner 38 are removed and predetermined processing (plating and the like), which is described below, is applied to the leader pin 30. Thus, the leader pin 30 is fabricated as a fabricated article as illustrated in FIG. 2.

Now, when the leader pin 30 (including the below-described overflow portions 36 and runner 38) is extracted from the cavity 44, positions at which the ejector pins 49 eject (protrude) are set to be at the overflow portions 36 (protruded portions) that are integrally joined to the head portions 34 of the leader pin 30 (see FIG. 5), in order for the shape of the leader pin 30 that is the fabricated article to not be damaged by the ejector pins 49 (i.e., such that ejection traces such as steps or the like are not formed on the leader pin 30 that is the fabricated article due to being pushed by the ejector pins 49).

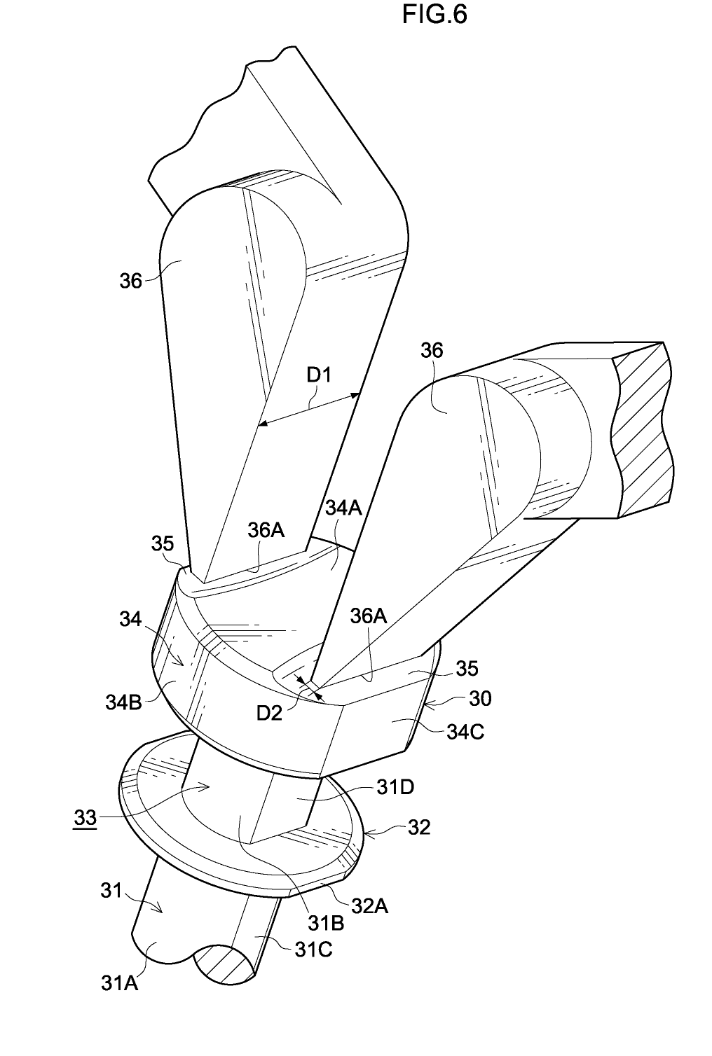

That is, when the leader pin 30 is fabricated by die-casting of a metal alloy, as illustrated in FIG. 6, it is desirable that pairs of the overflow portions 36 with substantial symmetry between left and right are formed in shapes with predetermined sizes that are joined to vicinities of peripheral edge portions (corner portion vicinities) of the outer faces 34A of the head portions 34. One of the overflow portions 36 (which is as a gate G) is joined to the runner 38 (see FIG. 5), which is made by a path along which the molten zinc alloy is injected.

As illustrated in FIG. 6, each of the overflow portions 36 is formed such that a plate thickness Dl thereof in the direction of ejection by the ejector pins 49 is relatively thick. Thus, rigidity of the overflow portions 36 when the leader pin 30 is ejected by the ejector pins 49 is assured. That is, the overflow portions 36 are strong with respect to forces applied in the direction of ejection by the ejector pins 49, and are formed with shapes (thicknesses) that are thoroughly capable of withstanding the pushing force when the leader pin 30 is ejected by the ejector pins 49.

Viewed in the direction of ejection by the ejector pins 49, each overflow portion 36 is formed in a substantial wedge shape, of which the side of a joining portion 36A that is joined to the outer face 34A of the head portion 34 narrows to a sharp point (acute angle). That is, the overflow portion 36 is formed such that a plate thickness D2 of the joining portion 36A in a direction orthogonal to the direction of ejection by the ejector pins 49 is very thin.

Thus, each overflow portion 36 has a structure that may be easily removed (cut) from the outer face 34A of the head portion 34. That is, the joining portion 36A of the overflow portion 36 has a shape that is weak (fragility) with respect to a force applied from the direction orthogonal to the direction of ejection by the ejector pins 49, and is easily cut off (removed) by a force being applied in this direction.

At the outer face 34A of each head portion 34 of the leader pin 30, notch portions 35 with a predetermined size (depth) are formed such that the head portion 34 is reduced in thickness, at portions of the peripheral edge portions (including the corner portions) that include the regions at which the joining portions 36A of the overflow portions 36 are joined. That is, the joining portion 36A of the overflow portion 36 is joined inside the notch portion 35.

Thus, traces (including a trace of the gate G) that are produced by the overflow portions 36 being removed (cut off) do not protrude from the outer face 34A of the head portion 34 of the leader pin 30. That is, this structure is capable of preventing the trace of the gate G from becoming an obstruction when the head portion 34 of the leader pin 30 is being retained at the pin retention portion 19 in the case 12.

These notch portions 35 may be formed at the head portions 34 of the leader pin 30 in a case in which at least the overflow portions 36 (including the gate G) are joined to the head portions 34. In other words, the notch portions 35 need not be formed if the overflow portions 36 are not joined to the head portions 34 of the leader pin 30.

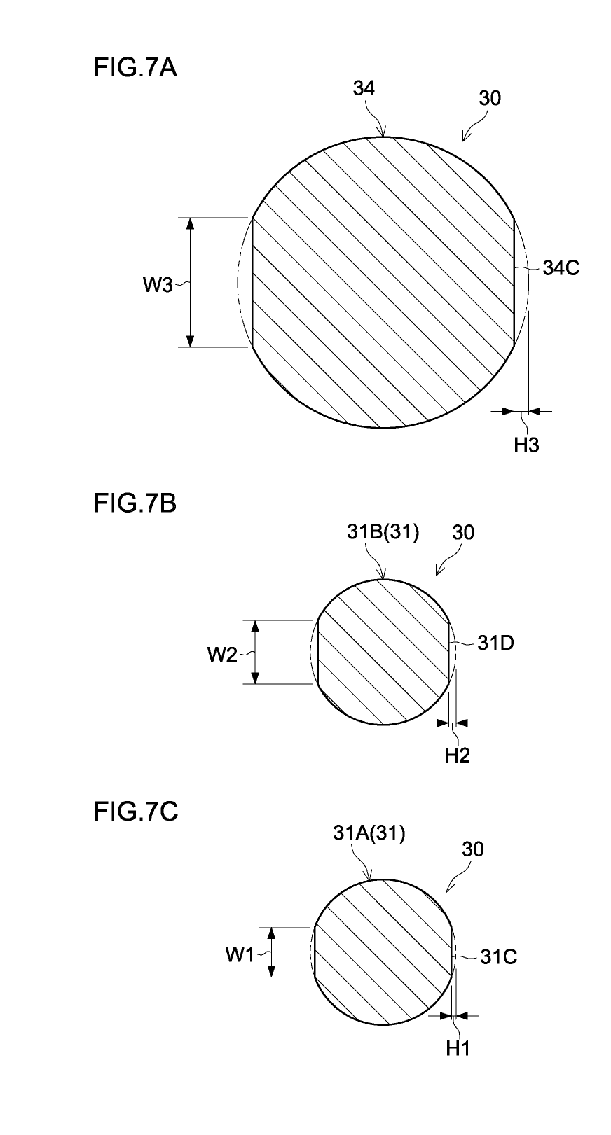

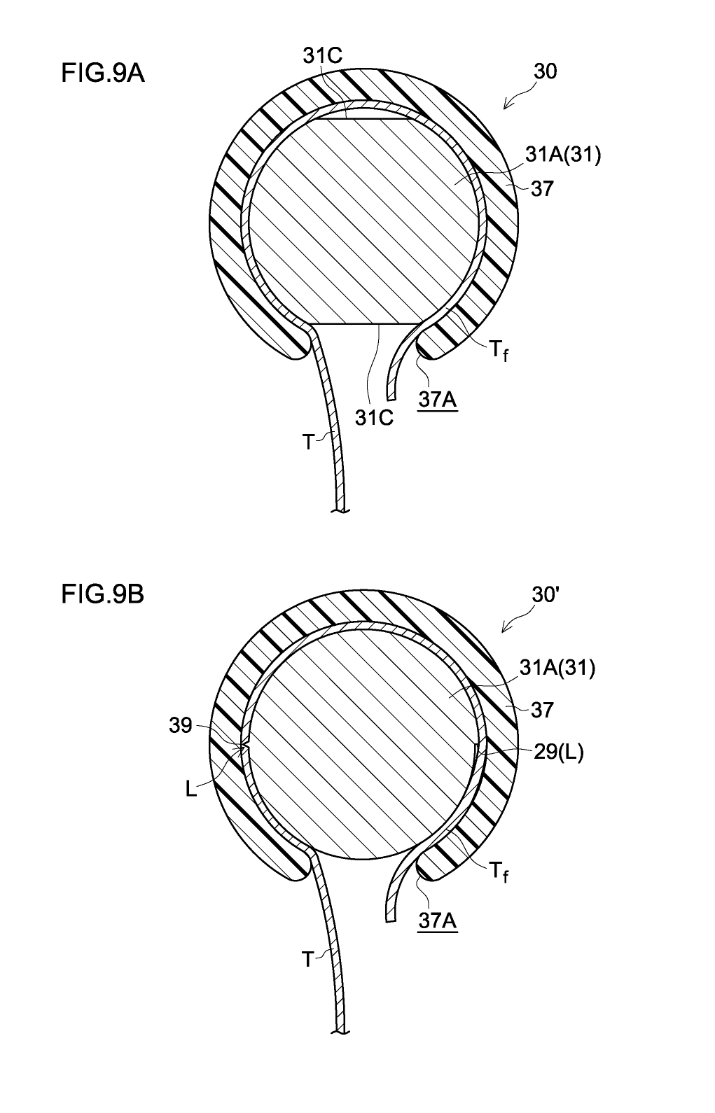

Parting line portions L (see FIG. 9B) are formed at the surface of the leader pin 30 that is produced in this manner (at the peripheral face of the main body portion 31 and the peripheral faces of the head portions 34 and the like). As illustrated in FIG. 9B, flashing 39 is formed at the parting line portion L and/or a step edge 29 is formed if there is a difference in machining dimensions of the core 42 and the cavity 44 and/or mold-clamping is carried out with the core 42 and the cavity 44 being mispositioned relative to one another, or the like. Accordingly, as illustrated in FIG. 2 and FIGS. 7A, 7B, 7C the leader pin 30 is made slightly thinner at portions of the leader pin 30 that correspond with the parting line portions L.

Here, the parting line portions L are portions of the leader pin 30, corresponding to boundary between the core 42 and the cavity 44.

That is, the leader pin 30 is cut flat (in what is known as D-cuts) at portions that correspond to the parting line portions L at the attachment portions 31A, the engaging portions 31B and the head portions 34 by predetermined depth (in radial direction of the leader pin 30) amounts H1, H2 and H3, respectively, along the axial direction. (H1<H2<H3; 0.005 mm≦(H1, H2, H3)≦0.04 mm; preferably, H1=0.01 mm, H2=0.02 mm, and H3=0.03 mm), namely, flat surface portions 31C, 31D and 34C of the attachment portions 31A, engaging portions 31B and head portions 34, respectively, are formed with left-right symmetry. As illustrated in FIG. 7A to FIG. 7C, widths W1, W2 and W3 of the flat surface portions 31C, 31D and 34C are such that W1<W2<W3.

As illustrated in FIG. 8 and FIG. 9A and FIG. 9B, the free end portion Tf of the recording tape T or the leader tape connected to the recording tape T is wound onto the attachment portion 31A of the leader pin 30, and a clip 37 fabricated of resin that is formed substantially in a “C” shape in cross-section, which serves as a clamp member, is fitted onto the periphery face of the attachment portion 31A. Thus, the free end portion Tf is attached (fixed) to the leader pin 30.

That is, the clip 37 is resiliently deformable such that a slit portion 37A opens up, and can nip (retain by pressing) the free end portion Tf of the recording tape T or the leader tape connected to the recording tape T against the attachment portion 31A by resilient restoration force.

The clip 37 is relatively non-rotatable with respect to the leader pin 30 even when the leader pin 30 (the head portions 34) is being drawn out from the pin retention portions 19 inside the case 12 and when the recording tape T is being wound back onto the reel 20 and the leader pin 30 being accommodated in the pin retention portions 19 inside the case 12 (i.e., when tension is applied to the free end portion Tf).

As illustrated in FIGS. 7A, 7B, 7C, the width W3 of each flat surface portion 34C of each head portion 34 and the width W2 of each flat surface portion 31D of each engaging portion 31B are made larger than the width W1 of each flat surface portion 31C of the attachment portion 31A. Therefore, as illustrated in FIG. 8, when the free end portion Tf of the recording tape T or the leader tape connected to the recording tape T is being attached to the attachment portion 31A of the leader pin 30, the leader pin 30 may be positioned in the circumferential direction thereof by the flat surface portion 34C of the head portions 34 being oriented downward so the leader pin 30 being placed on a flat surface 50A of a support pedestal 50.

Thus, as illustrated in FIG. 9A, the free end portion Tf is be attached to the attachment portion 31A (the leader pin 30) such that the flat surface portion 31C of the attachment portion 31A faces the slit portion 37A of the clip 37 (such that the one of the flat surface portions 31C of the attachment portion 31A is positioned at the slit portion 37A side of the clip 37 and the other of the flat surface portions 31C of the attachment portion 31A is positioned at the side of the clip 37 opposite to the slit portion 37A side). In other words, as illustrated in FIGS. 10 A and 10B, the free end portion Tf is be attached to the attachment portion 31A (the leader pin 30) such that an angle (when viewed along the axial direction of the leader pin 30) (an attitude) of the leader pin 30 with respect to a tension direction S of the free end portion Tf of the recording tape T or the leader tape connected to the recording tape T at time of mounting and removal operations of the leader pin 30 is an angle such that the flat surface portions 34C formed at each head portion 34 do not touch against the distal end portions 27A of the plate spring 27 (in other words, such that only the peripheral face portions 34B (peripheral faces of the head portion 34 other than the flat surface portions 34C) of each head portion 34 touch the distal end portions 27A of the plate spring 27).

Namely, the free end portion Tf is be attached to the attachment portion 31A (the leader pin 30) such that the flat surface portions 34C formed at each head portion 34 do not touch against the distal end portions 27A of the plate spring 27 (such that only the peripheral face portions 34B of each head portion 34 touch the distal end portions 27A of the plate spring 27) when the leader pin 30 entering to (and going out from) the pin retention portions 19 as illustrated in FIG. 10B, and in a state in which the leader pin 30 (the head portions 34) is retained at the case 12 (the pin retention portions 19) as illustrated in FIG. 10A.

As illustrated in FIG. 2 and FIG. 8, it is desirable if a flat surface portion 32A is formed at a portion of each flange portion 32 that corresponds with a parting line portion L, such that the flange portions 32 do not interfere with the flat surface 50A of the support pedestal 50 when the leader pin 30 is placed on the flat surface 50A. Accordingly, the leader pin 30 that is placed on the flat surface 50A of the support pedestal 50 can be more reliably stabilized.

Next, operation of the leader pin 30 with the above structure is described. As described above, a material of the leader pin 30 is one of the metallic alloy from among the zinc alloy, the aluminium alloy, the magnesium alloy and the copper alloys, and the leader pin 30 is fabricated by a die-casting fabrication process (with the die 40).

The metallic alloy has larger thermal conductivity than that of a plastic. The metallic alloy has smaller specific heat than that of a plastic. Therefore, by die-casting, one-shot processing in 2 to 10 seconds is possible. That is, in a case in which the leader pin 30 is fabricated by die-casting of a metal alloy, productivity can be improved over compared with a case in which a leader pin is fabricated by cutting and machining stainless steel (not illustrated in the drawings).

Furthermore, because the material of the leader pin 30 is a metallic alloy from the among zinc alloy, the aluminium alloy, the magnesium alloy and the copper alloy, the leader pin 30 can be fabricated at low cost, and because the leader pin 30 is fabricated of metal, the leader pin 30 has excellent strength, stiffness, low-friction characteristics and abrasion resistance compared to a leader pin that is made of plastic (not illustrated in the drawings) (including fiber-reinforced plastics with carbon fibers and suchlike). Further, the leader pin 30 fabricated of a metal alloy has comparatively excellent corrosion resistance.

To be particular, if the material is a copper alloy, it is excellent in corrosion resistance, low-friction characteristics and abrasion resistance. If the material is a zinc alloy, dimensional precision at die-cast is excellent, endurance of the die 40 is excellent, and recycling characteristics are excellent. If the material is an aluminium alloy or a magnesium alloy, the leader pin 30 can be fabricated with a further light weight, and consequently, when the recording tape cartridge 10 is subjected to an impact from a fall, an inertial force applied to the leader pin 30 is small, and the leader pin 30 is unlikely to disengage from the pin retention portions 19.

That is, the leader pin 30 relating to the present exemplary embodiment, which is fabricated by a die-casting method from a material that is a metal alloy selected from the zinc alloy, the aluminium alloy, the magnesium alloy and the copper alloy, has an excellent balance between productivity and various other characteristics, and can be fabricated at low cost. Therefore, by this leader pin 30 being employed, manufacturing costs of the recording tape cartridge 10 can be lowered.

It is desirable that the surface of the leader pin 30 that is produced thus is subjected to nickel plating or hard chrome plating, further, it is desirable that polytetrafluoroethylene (PTFE) processing is applied. Thus, low-friction characteristics and abrasion resistance of the leader pin 30 can be improved. Further, the surface of the leader pin 30 may be subjected to chrome plating or chromate processing. Thus, corrosion resistance (endurance) of the leader pin 30 can be improved.

As well as the leader pin 30, treatments similar to those described above may be applied to the plate spring 27. Thus, low-friction characteristics and abrasion resistance with respect to the leader pin 30 can be improved. Furthermore, by injection molding after the application of an electrochemical treatment to the whole of the leader pin 30, a resin coating may be applied just to the head portions 34. Accordingly, low-friction characteristics at least of the head portions 34 that come into contact with the distal end portions 27A of the plate spring 27 can be improved. As a resin material in such a case, polyamide (PA), polyphenylene sulfide (PPS) and the like can be mentioned.

The leader pin 30 is formed with the widths W1, W2 and W3 of the flat surface portions 31C, 31D and 34C of the attachment portion 31A, engaging portions 31B and head portions 34 having the relationship “W1<W2<W3”. Therefore, as illustrated in FIG. 8, when the free end portion Tf of the recording tape T or the leader tape connected to the recording tape T is being attached to the attachment portion 31A by the clip 37, the leader pin 30 can be stably disposed on the flat surface 50A of the support pedestal 50 by means of the flat surface portions 34C of the head portions 34.

That is, because the leader pin 30 can be positioned in the circumferential direction thereof, an attachment (fitting) operation of the clip 37 to the attachment portion 31A is easier, and the clip 37 can always be fitted to the attachment portion 31A (the main body portion 31) from a particular direction. That is, as illustrated in FIG. 9A, the clip 37 can be fitted (fixed) to the attachment portion 31A, to be relatively non-rotatable, such that the flat surface portion 31C of the attachment portion 31A always faces the slit portion 37A of the clip 37.

As illustrated in FIG. 9B, with a leader pin 30′ relating to a comparative example, in which the flat surface portions 31C are not formed at the regions of the attachment portion 31A that correspond to the parting line portions L, the free end portion Tf that is nipped (pressed and retained) between the clip 37 and the attachment portion 31A may be damaged or cut by the flashing 39, step edge 29 or the like formed at the parting line portion L of the attachment portion 31A.

In contrast, as illustrated in FIG. 9A, with the leader pin 30 relating to the present exemplary embodiment, the flat surface portions 31C are formed at the regions of the attachment portion 31A that correspond to the parting line portions L, and the flashing 39, step edge 29 and the like are removed. Therefore, even if the free end portion Tf that is wound on the attachment portion 31A of the leader pin 30 is pressed and retained by the clip 37, there is no risk of the free end portion Tf being damaged or cut.

In addition, because the flat surface portions 34C are formed at the regions of the head portions 34 that correspond to the parting line portions L and the flashing 39, step edge 29 and the like are also removed from the head portions 34, a situation in which an outer diameter of the head portions 34 (the diameter in a direction orthogonal to the axial direction) becomes larger due to the flashing 39, step edge 29 or the like and causes variations in insertion force and removal force of the head portions 34 at the pin retention portions 19 can be prevented.

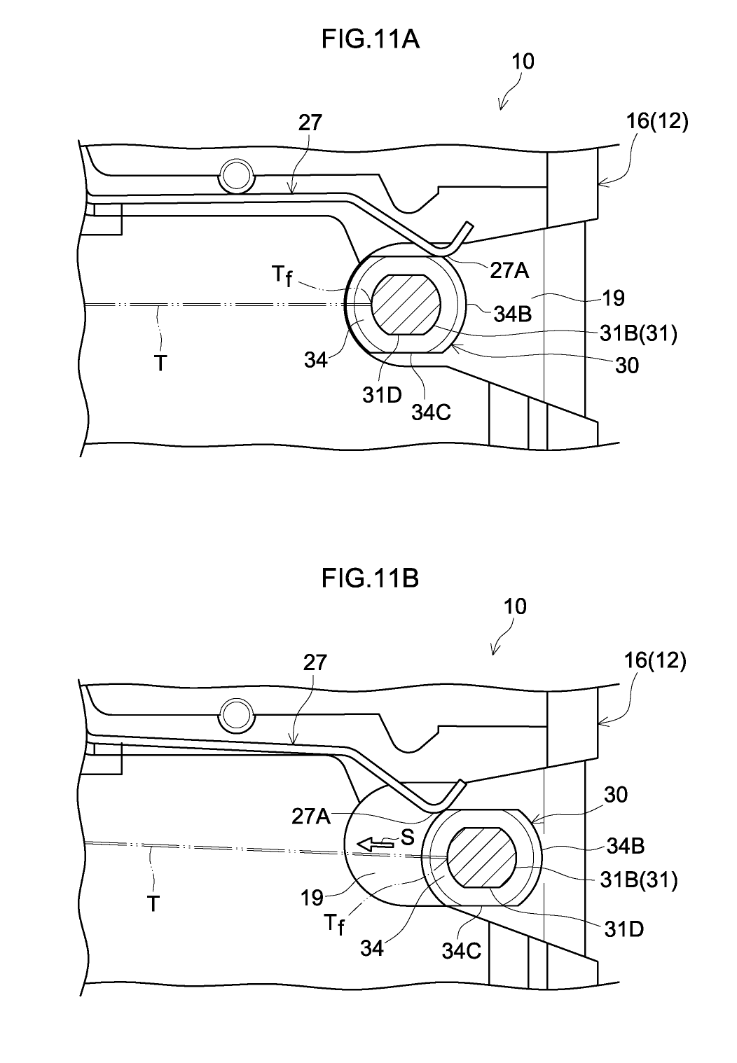

In a comparative example illustrated in FIG. 11A and FIG. 11B, the free end portion Tf of the recording tape T or the leader tape connected to the recording tape T is attached to the attachment portion 31A of the leader pin 30 such that, with respect to a tension direction S on the free end portion Tf, the flat surface portions 34C formed at the head portions 34 are at angles such that the flat surface portions 34C are in contact with the distal end portions 27A of the plate spring 27.

Therefore, in this comparative example, when the leader pin 30 (the head portions 34) is being mounted at or removed from the pin retention portions 19 inside the case 12, spring forces of the distal end portions 27A of the plate spring 27 on the head portions 34 may be inconsistent (instable), and it may not be possible to properly retain the head portions 34.

In contrast, as illustrated in FIG. 9A and FIG. 10A and FIG. 10B, with the leader pin 30, the free end portion Tf of the recording tape T or the leader tape connected to the recording tape T is attached to the attachment portion 31A of the leader pin 30 such that, with respect to the tension direction S on the free end portion Tf, the flat surface portions 34C formed at the head portions 34 are at angles so as not to be in contact with the distal end portions 27A of the plate spring 27 (such that, with respect to the tension direction S on the free end portion Tf, the leader pin 30 is at an angle such that the flat surface portions 34C formed at the head portions 34 do not contact with the distal end portions 27A of the plate spring 27).

That is, the free end portion Tf of the recording tape T or the leader tape connected to the recording tape T is attached to the attachment portion 31A of the leader pin 30 such that, with respect to the tension direction S on the free end portion Tf, the angle of the leader pin 30 is such that only the peripheral face portion 34B that is formed in a circular arc shape in plan view (a circular arc shape as viewed in the axial direction of the leader pin 30) at each head portion 34 is in contact with each distal end portion 27A of the plate spring 27.

Thus, when the leader pin 30, which is fabricated by die-casting of a metallic alloy and at which the flat surface portions 31C, 31D and flat surface portions 34C are formed at the parting line portions L, is accommodated at the pin retention portions 19 inside the case 12, the head portions 34 can be properly retained by the distal end portions 27A of the plate spring 27. Thus, failures of engagement with the distal end portions 27A of the plate spring 27 that engage with the head portions 34 of the leader pin 30 can be suppressed or prevented.

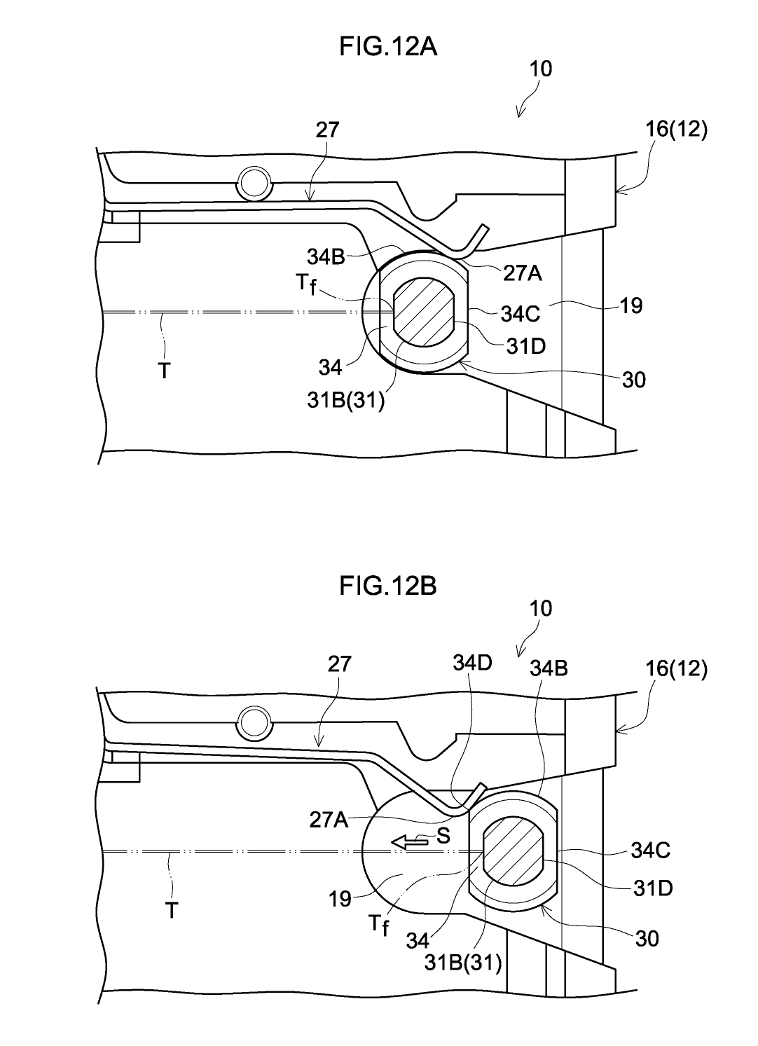

The width W3 of each flat surface portion 34C of the head portions 34 must not be excessively large as in the comparative example illustrated in FIG. 12A and FIG. 12B. That is, when the leader pin 30 (the head portions 34) in such a case is being accommodated in the pin retention portions 19 in the case 12, there would be a risk that a boundary region between the flat surface portion 34C and the peripheral face portion 34B (hereinafter referred to as an edge portion 34D) might make strong contact with the distal end portion 27A of the plate spring 27 and abrade, and that the head portion 34 of the leader pin 30 might be abraded by the distal end portion 27A of the plate spring 27.

Therefore, an upper limit of the width W3 of the flat surface portions 34C of each head portion 34 is set such that the edge portion 34D of the head portion 34 will not interfere with the distal end portion 27A of the plate spring 27 (i.e., such that only the peripheral face portion 34B comes into contact with the distal end portion 27A) when the leader pin 30 (the head portions 34) is being mounted at or removed from the pin retention portions 19 (The upper limit of the D-cut amount H3 that determines the width W3 is set to 0.04 mm). Thus, abrasion of the head portions 34 of the leader pin 30 can be suppressed or prevented.

Hereabove, the recording tape cartridge 10 relating to the present exemplary embodiment has been described in accordance with the attached drawings. However, the recording tape cartridge 10 relating to the present exemplary embodiment is not limited to the illustrated recording tape cartridge; suitable modifications of design are possible within a technical scope not departing from the spirit of the present invention. For example, depending on the shape of the support pedestal 50, the flat surface portions 31D of the engaging portions 31B may be supported rather than the flat surface portions 34C of the head portions 34.

Further, the flat surface portions 34C of each head portion 34 illustrated in FIG. 7A are formed with matching widths (the same widths), with left-right symmetry. However, a constitution is possible in which the width of the flat surface portion 34C at the side that does not face the slit portion 37A is made smaller than the width of the flat surface portion 34C at the side that faces the slit portion 37A, so that the distal end portion 27A of the plate spring 27 is more reliably engaged by the peripheral face portion 34B of the head portion 34. That is, the flat surface portions 31C, 31D and 34C are not necessarily formed with the same widths with left-right symmetry.

What is claimed is:

1. A recording tape cartridge comprising:
a reel around which a recording tape is wound;
a case that singly accommodates the reel in a rotatable manner;
a leader pin that is manufactured by die-casting of one of a zinc alloy, an aluminium alloy, a magnesium alloy or a copper alloy, and that is attached to a free end portion of one of the recording tape or of a sheet-form member connected to the recording tape, the leader pin being drawn out through an opening formed in the case by a drawing member of a drive device;
a plate spring that retains both end portions of the leader pin in an axial direction thereof such that the leader pin does not fall from inside the case and that, when the leader pin is being mounted at or removed from the case, resiliently deforms due to being pushed by the both end portions to allow mounting and removal operations of the leader pin; and
flat surface portions formed at the leader pin such that parting line portions of the leader pin are removed,
wherein the leader pin is attached to the free end portion such that an angle of the leader pin with respect to a tension direction of the free end portion is an angle such that the flat surface portions formed at the both end portions do not come into contact with the plate spring.

2. A recording tape cartridge comprising:
a reel around which a recording tape is wound;
a case that singly accommodates the reel in a rotatable manner;
a leader pin that is manufactured by die-casting of one of a zinc alloy, an aluminium alloy, a magnesium alloy or a copper alloy, and that is attached to a free end portion of one of the recording tape or of a sheet-form member connected to the recording tape, the leader pin being drawn out through an opening formed in the case by a drawing member of a drive device;
a plate spring that retains both end portions of the leader pin in an axial direction thereof such that the leader pin does not fall from inside the case and that, when the leader pin is being mounted at or removed from the case, resiliently deforms due to being pushed by the both end portions to allow mounting and removal operations of the leader pin; and
flat surface portions formed at at least the both end portions of the leader pin corresponding to parting line portions of the leader pin,
wherein the leader pin is attached to the free end portion such that an angle of the leader pin with respect to a tension direction of the free end portion is an angle such that the flat surface portions formed at the both end portions do not come into contact with the plate spring.

3. The recording tape cartridge of claim 1, wherein the leader pin includes:
head portions that are formed at the both end portions of the leader pin and have a thick plate shape, the head portions being retained by the plate spring;
flange portions that are formed at the axial direction inner sides relative to the head portions and have a thin plate shape; and
a main body portion that is between the flange portions and to which the free end portion is attached,
and wherein a width of the flat surface portion formed at the head portion is larger than a width of the flat surface portion formed at the main body portion.

4. The recording tape cartridge of claim 2, wherein the leader pin includes:
head portions that are formed at the both end portions of the leader pin and have a thick plate shape, the head portions being retained by the plate spring;
flange portions that are formed at the axial direction inner sides relative to the head portions and have a thin plate shape; and
a main body portion that is between the flange portions and to which the free end portion is attached,
and wherein a width of the flat surface portion formed at the head portion is larger than a width of the flat surface portion formed at the main body portion.

5. The recording tape cartridge of claim 1, wherein the leader pin is subjected to surface processing including polytetrafluoroethylene processing.

6. The recording tape cartridge of claim 2, wherein the leader pin is subjected to surface processing including polytetrafluoroethylene processing.

7. The recording tape cartridge of claim 1, wherein the plate spring is subjected to surface processing including polytetrafluoroethylene processing.

8. The recording tape cartridge of claim 2, wherein the plate spring is subjected to surface processing including polytetrafluoroethylene processing.

9. The recording tape cartridge of claim 1, wherein the leader pin is resin-coated only at the both end portions that are retained by the plate spring.

10. The recording tape cartridge of claim 2, wherein the leader pin is resin-coated only at the both end portions that are retained by the plate spring.

11. The recording tape cartridge of claim 1, further comprising a retention portion that retains the leader pin inside the case,
wherein the leader pin is attached to the free end portion such that the flat surface portions formed at the both end portions do not come into contact with the plate spring in a state in which the leader pin is retained at the retention portion.

12. The recording tape cartridge of claim 2, further comprising a retention portion that retains the leader pin inside the case,
wherein the leader pin is attached to the free end portion such that the flat surface portions formed at the both end portions do not come into contact with the plate spring in a state in which the leader pin is retained at the retention portion.

13. The recording tape cartridge of claim 1, further comprising a retention portion that retains the leader pin inside the case,
wherein the leader pin is attached to the free end portion such that the flat surface portions formed at the both end portions do not come into contact with the plate spring at time of mounting to and removal from the retention portion of the leader pin.

14. The recording tape cartridge of claim 2, further comprising a retention portion that retains the leader pin inside the case,
wherein the leader pin is attached to the free end portion such that the flat surface portions formed at the both end portions do not come into contact with the plate spring at time of mounting to and removal from the retention portion of the leader pin.
